(19) United States
(12) Patent Application Publication
(10) Pub. No.: US 2012/0321210 A1
(43) Pub. Date: Dec. 20, 2012

(54) SYSTEMS AND METHODS FOR THEMATIC MAP CREATION

(76) Inventors: Michael Scott Forbes, Seattle, WA (US); Therese Louise Connor, Seattle, WA (US)

(21) Appl. No.: 13/323,620

(22) Filed: Dec. 12, 2011

Related U.S. Application Data
(60) Provisional application No. 61/422,187, filed on Dec. 12, 2010.

(51) Int. Cl. G06K 9/40

(52) U.S. Cl. 382/254

(57) ABSTRACT

This invention relates generally to systems and methods thematic map creation. In one embodiment, a method includes, but is not limited to, receiving at least one indication of at least one region associated with at least one image; determining at least one parameter value for the at least one region; and providing at least one enhancement for the at least one region based on the at least one parameter value.

### PRIORITY CLAIM

This application claims priority to and is a non-provisional of U.S. provisional patent application Ser. No. 61/422,187 filed Dec. 12, 2010. The foregoing application is incorporated by reference in its entirety as if fully set forth herein.

### FIELD OF THE INVENTION

This invention relates generally to systems and methods for thematic map creation.

### SUMMARY

This invention relates generally to systems and methods thematic map creation. In one embodiment, a system includes, but is not limited to, circuitry configured for receiving at least one indication of at least one region associated with at least one image; circuitry configured for determining at least one parameter value for the at least one region; and circuitry configured for providing at least one enhancement for the at least one region based on the at least one parameter value. In another embodiment, a method includes, but is not limited to, receiving at least one indication of at least one region associated with at least one image; determining at least one parameter value for the at least one region; and providing at least one enhancement for the at least one region based on the at least one parameter value. In another embodiment, one or more computer readable media bear one or more instructions for facilitating operations including, but not limited to, receiving at least one indication of at least one region associated with at least one image; determining at least one parameter value for the at least one region; and providing at least one enhancement for the at least one region based on the at least one parameter value. In another embodiment, a system includes, but is not limited to, means for receiving at least one indication of at least one region associated with at least one image; means for determining at least one parameter value for the at least one region; and means for providing at least one enhancement for the at least one region based on the at least one parameter value.

### BRIEF DESCRIPTION OF THE DRAWINGS

Embodiments of the present invention are described in detail below with reference to the following drawings:

FIG. 1 is a screenshot of an application for thematic map creation operating on a computer, in accordance with an embodiment of the invention;

FIGS. 2-9 are block diagrams of method operations for thematic map creation, in accordance with various embodiments of the invention;

FIG. 10 is a diagram of computer readable media bearing one or more instructions for thematic map creation;

FIG. 11 is a diagram of a system for thematic map creation; and

FIG. 12 is a diagram of a system for thematic map creation.

### DETAILED DESCRIPTION

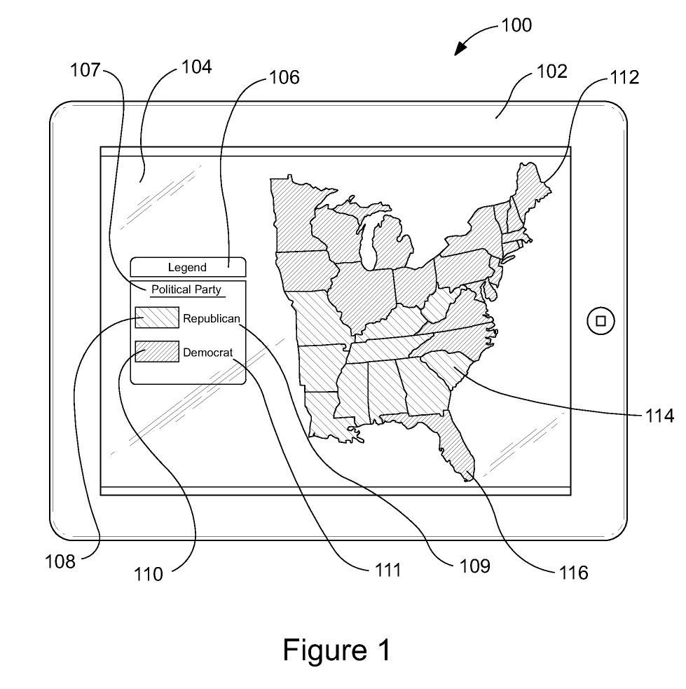

This invention relates generally to systems and methods thematic map creation. Specific details of certain embodiments of the invention are set forth in the following description and in FIGS. 1-12 to provide a thorough understanding of such embodiments. The present invention may have additional embodiments, may be practiced without one or more of the details described for any particular described embodiment, or may have any detail described for one particular embodiment practiced with any other detail described for another embodiment.

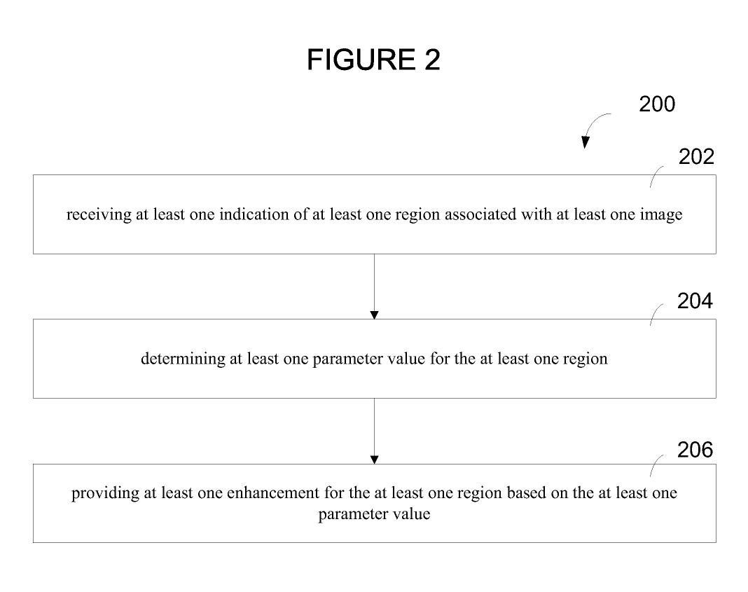

FIG. 1 is a screenshot of an application for thematic map creation operating on a computer, in accordance with an embodiment of the invention. In one specific embodiment, system 100 includes an application 104 operating on a computer 102. Computer 102 may include a tablet PC, a mobile phone, a personal digital assistant, a personal computer, a laptop, a gaming device, a television, a projector, or any other device having a processing component. Application 104 may perform or be implemented in association with one or more details disclosed in reference to FIGS. 2-12. Application 104 includes a legend 106 having a first parameter 107 with a first parameter value 109 and a second parameter value 111. The first parameter value 109 is associated with a first visual enhancement 108. The second parameter value 111 is associated with a second visual enhancement 110. The first parameter 107, the first parameter value 109, the first visual enhancement 108, the second parameter value 111, and the second visual enhancement 110 are user-definable. Application 104 includes an image 112 having a first region 114 and a second region 116. The image 112 is imported or user-created and the first region 114 and the second region 116 are user-defined relative to the image 112. The first region 114 is associated with the first parameter value 109 and incorporates the first visual enhancement 108. The second region 116 is associated with the second parameter value 111 and incorporates the second visual enhancement 110. The association between the first region 114 and the first parameter value 109 and the association between the second region 116 and the second parameter value 111 are user-defined. Accordingly, for example, system 100 enables a user to import a map image of the United States from GOOGLE MAPS and define regions corresponding to States by clicking on each State. The user can create a Political Party legend specifying Republican and Democrat and specify enhancements of forward and backward cross-hatching, respectively. The user can then click on each State and select (from a list populated based on the user-created legend) either Republican or Democrat thereby resulting in the Republican designated states to incorporate a forward hatch enhancement and the Democrat designated states to incorporate a backward hatch enhancement. The foregoing example is for illustrative purposes and should not be construed as limiting in nature.

FIG. 2 is a block diagram of method operations for thematic map creation, in accordance with an embodiment of the invention. In one embodiment, method 200 includes receiving at least one indication of at least one region associated with at least one image at block 202, determining at least one parameter value for the at least one region at block 204, and providing at least one enhancement for the at least one region based on the at least one parameter value at block 206. Method 200 may be performed by one or more computer processing devices.

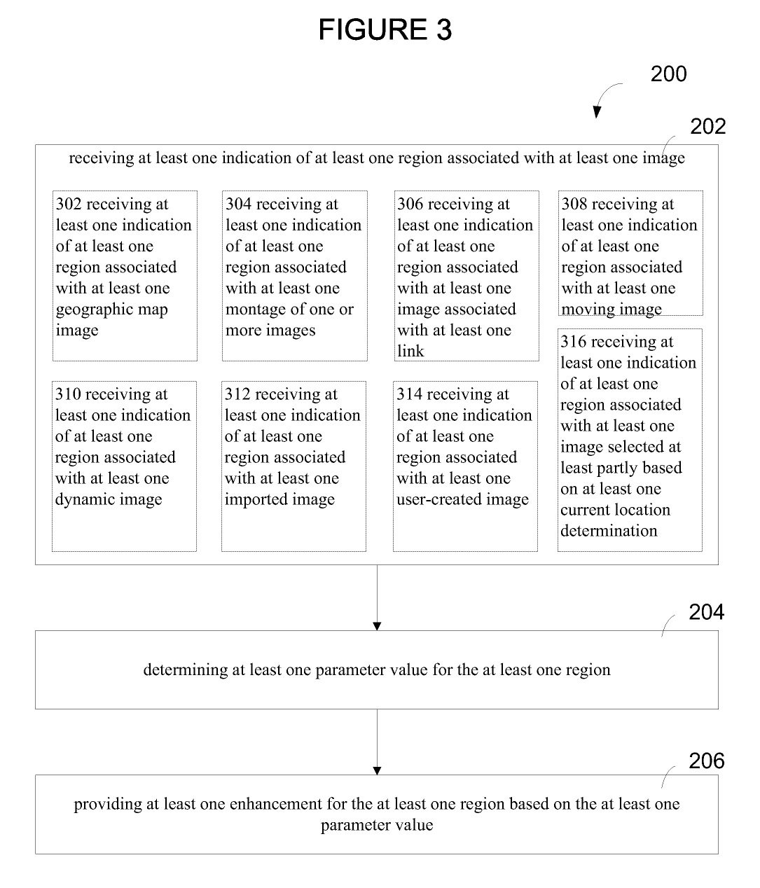

FIG. 3 is a block diagram of method operations for thematic map creation, in accordance with various embodiments of the invention. In one embodiment, method 200 includes receiving at least one indication of at least one region associated with at least one geographic map image at block 302, receiving at least one indication of at least one region associated with at least one montage of one or more images at block 304, receiving at least one indication of at least one region associated with at least one image associated with at least one link at block 306, receiving at least one indication of at least one region associated with at least one moving image at block 308, receiving at least one indication of at least one region associated with at least one dynamic image at block 310, receiving at least one indication of at least one region associated with at least one 110 imported image at block 312, receiving at least one indication of at least one region associated with at least one user-created image at block 314, and/or receiving at least one indication of at least one region associated with at least one image selected at least partly based on at least one current location determination at block 316.

In one embodiment, receiving at least one indication of at least one region associated with at least one geographic map image at block 302 includes receiving at least one indication of at least one region associated with at least one country map image. In another embodiment, receiving at least one indication of at least one region associated with at least one geographic map image at block 302 includes receiving at least one indication of at least one region associated with at least one city map image. In a further embodiment, receiving at least one indication of at least one region associated with at least one geographic map image at block 302 includes receiving at least one indication of at least one region associated with at least one satellite map image. In an additional embodiment, receiving at least one indication of at least one region associated with at least one geographic map image at block 302 receiving at least one indication of at least one region associated with at least one GOOGLE map image.

In one embodiment, receiving at least one indication of at least one region associated with at least one montage of one or more images at block 304 includes receiving at least one indication of at least one region associated with at least one montage of similar and/or different images, such as downtown areas of LA, Seattle, New York, or the like. In another embodiment, receiving at least one indication of at least one region associated with at least one montage of one or more images at block 304 includes receiving at least one indication of at least one region associated with at least one montage of independently and/or collectively movable, modifiable, and/or hidable images. In a further embodiment, receiving at least one indication of at least one region associated with at least one montage of one or more images at block 304 includes receiving at least one indication of at least one region associated with at least one montage of images selected based on one or more criteria, such as concentrated wealth areas, existence of disease instances, areas of higher crime, and the like. In an additional embodiment, receiving at least one indication of at least one region associated with at 140 least one montage of one or more images at block 304 includes receiving at least one indication of at least one region associated with at least one montage of user-specified images.

In one embodiment, receiving at least one indication of at least one region associated with at least one image associated with at least one link at block 306 includes receiving at least one indication of at least one region associated with at least one image associated with at least one link to at least one other region and/or image. In another embodiment, receiving at least one indication of at least one region associated with at least one image associated with at least one link at block 306 includes receiving at least one indication of at least one region associated with at least one image associated with at least one hyperlink. In a further embodiment, receiving at least one indication of at least one region associated with at least one image associated with at least one link at block 306 includes receiving at least one indication of at least one region associated with at least one image associated with at least one social networking, contact, and/or communication link. In an additional embodiment, receiving at least one indication of at least one region associated with at least one image associated with at least one link at block 306 includes receiving at least one indication of at least one region associated with at least one image associated with at least one camera, and/or video link. In another embodiment, receiving at least one indication of at least one region associated with at least one image associated with at least one link at block 306 includes receiving at least one indication of at least one region associated with at least one image associated with at least one user-specified link. In one embodiment, receiving at least one indication of at least one region associated with at least one image associated with at least one link at block 306 includes receiving at least one indication of at least one region associated with at least one image associated with at least one document, file, contact, and/or social media network type link.

In one embodiment, receiving at least one indication of at least one region associated with at least one moving image at block 308 includes receiving at least one indication of at least one region associated with at least one panning image. In another embodiment, receiving at least one indication of at least one region associated with at least one moving image at block 308 includes receiving at least one indication of at least one region associated with at least one zooming image. In a further embodiment, receiving at least one indication of at least one region associated with at least one moving image at block 308 includes receiving at least one indication of at least one region associated with at least one video and/or sequence of images, such as a tour through a shopping area, neighborhood, city, countryside, or the like.

In one embodiment, receiving at least one indication of at least one region associated with at least one dynamic image at block 310 includes receiving at least one indication of at least one region associated with at least one image that changes over time to reflect updates, such as updates in roadways, population centers, districting, zoning, building, or the like. In another embodiment, receiving at least one indication of at least one region associated with at least one dynamic image at block 310 includes receiving at least one indication of at least one region associated with at least one image that changes per one or more subscription agreements. In a further embodiment, receiving at least one indication of at least one region associated with at least one dynamic image at block 310 includes receiving at least one indication of at least one region associated with at least one image that changes in response to user-request. In one embodiment, receiving at least one indication of at least one region associated with at least one dynamic image at block 310 includes receiving at least one indication of at least one region associated with at least one image that changes automatically.

In one embodiment, receiving at least one indication of at least one region associated with at least one imported image at block 312 includes receiving at least one indication of at least one region associated with at least one imported KML, KMZ, shapefile, tiger/line, and/or GIS type image. In another embodiment, receiving at least one indication of at least one region associated with at least one imported image at block 312 includes receiving at least one indication of at least one region associated with at least one imported GOOGLE maps type image. In a further embodiment, receiving at least one indication of at least one region associated with at least one imported image at block 312 includes receiving at least one indication of at least one region associated with at least one downloaded image. In an alternative embodiment, receiving at least one indication of at least one region associated with at least one imported image at block 312 includes receiving at least one indication of at least one region associated with at least one image shared and/or obtained from at least one other device, application, or individual.

In one embodiment, receiving at least one indication of at least one region associated with at least one user-created image at block 314 includes receiving at least one indication of at least one region associated with at least one drawn image. In another embodiment, receiving at least one indication of at least one region associated with at least one user-created image at block 314 includes receiving at least one indication of at least one region associated with at least one photographed image. In a further embodiment, receiving at least one indication of at least one region associated with at least one user-created image at block 314 includes receiving at least one indication of at least one region associated with at least one visual-editor-type software created image. In an additional embodiment, receiving at least one indication of at least one region associated with at least one user-created image at block 314 includes receiving at least one indication of at least one region associated with at least one image recognized from one or more sketches, such as an image of the USA recognized from a rough outline sketch of the USA.

In one embodiment, receiving at least one indication of at least one region associated with at least one image selected at least partly based on at least one current location determination at block 316 includes receiving at least one indication of at least one region associated with at least one image selected at least partly based on at least one current GPS location, such as an image map of Seattle based upon a GPS location of Seattle. In another embodiment, receiving at least one indication of at least one region associated with at least one image selected at least partly based on at least one current location determination at block 316 includes receiving at least one indication of at least one region associated with at least one image selected from a list of options presented based at least partly on at least one current location determination. In a further embodiment, receiving at least one indication of at least one region associated with at least one image selected at least partly based on at least one current location determination at block 316 includes receiving at least one indication of at least one region associated with at least one image selected at least partly based on at least one user-specified location. In one embodiment, receiving at least one indication of at least one region associated with at least one image selected at least partly based on at least one current location determination at block 316 includes receiving at least one indication of at least one region associated with at least one image tracking at least one location, such as an image of a neighborhood while driving and/or an image of stores while shopping.

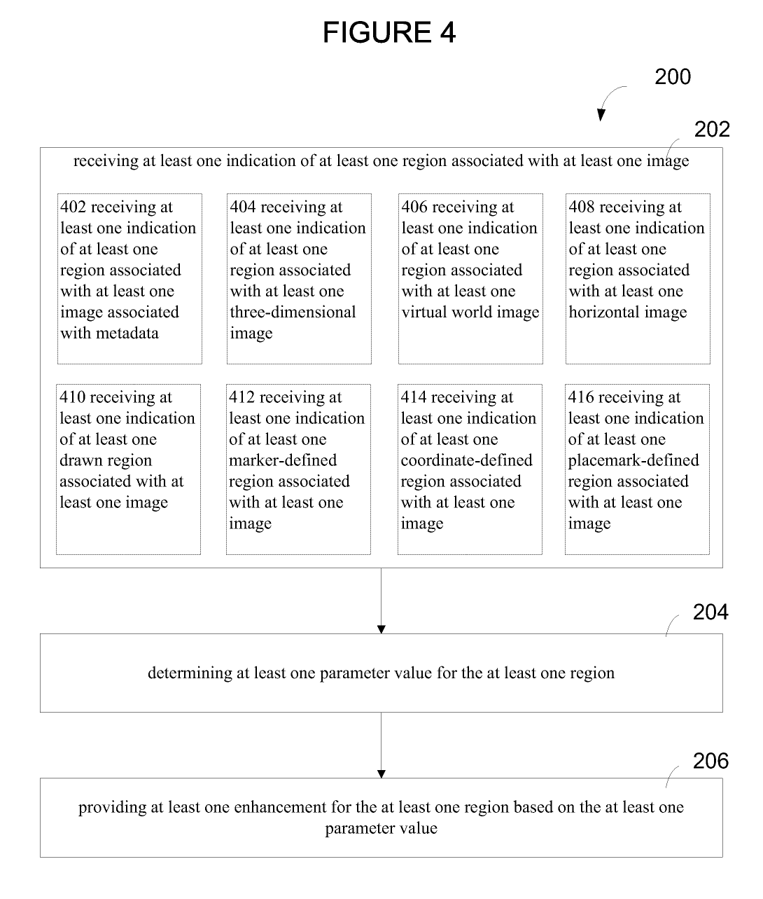

FIG. 4 is a block diagram of method operations for thematic map creation, in accordance with various embodiments of the invention. In one embodiment, method 200 includes receiving at least one indication of at least one region associated with at least one image associated with metadata at block 402, receiving at least one indication of at least one region associated with at least one three-dimensional image at block 404, receiving at least one indication of at least one region associated with at least one virtual world image at block 406, receiving at least one indication of at least one region associated with at least one horizontal image 408, receiving at least one indication of at least one drawn region associated with at least one image at block 410, receiving at least one indication of at least one marker-defined region associated with at least one image at block 412, receiving at least one indication of at least one coordinate-defined region associated with at least one image at block 414, and/or receiving at least one indication of at least one placemark-defined region associated with at least one image at block 416.

In one embodiment, receiving at least one indication of at least one region associated with at least one image associated with metadata at block 402 includes receiving at least one indication of at least one region associated with at least one image associated with user specified note, title, and/or subtext information or the like. In another embodiment, receiving at least one indication of at least one region associated with at least one image associated with metadata at block 402 includes receiving at least one indication of at least one region associated with at least one image associated with searchable metadata. In a further embodiment, receiving at least one indication of at least one region associated with at least one image associated with metadata at block 402 includes receiving at least one indication of at least one region associated with at least one image associated with collaborative input, such as information received from one or more viewers, students, associates, colleagues, or the like.

In one embodiment, receiving at least one indication of at least one region associated with at least one three-dimensional image at block 404 includes receiving at least one indication of at least one region associated with at least one perspective geographic view, such as a bird's eye view of land and/or improvements. In another embodiment, receiving at least one indication of at least one region associated with at least one three-dimensional image at block 404 includes receiving at least one indication of at least one region associated with at least one commercial and/or residential building, such as a large city skyscraper or condominium building. In a further embodiment, receiving at least one indication of at least one region associated with at least one three-dimensional image at block 404 includes receiving at least one indication of at least one region associated with at least one plumbing, electrical, computer, communication, or other system. In a further embodiment, receiving at least one indication of at least one region associated with at least one three-dimensional image at block 404 includes receiving at least one indication of at least one region associated with at least one body or body component.

In one embodiment, receiving at least one indication of at least one region associated with at least one virtual world image at block 406 includes receiving at least one indication of at least one region associated with at least one SECOND LIFE type image. In another embodiment, receiving at least one indication of at least one region associated with at least one virtual world image at block 406 includes receiving at least one indication of at least one region associated with at least one video game, movie, television show image or the like. In a further embodiment, receiving at least one indication of at least one region associated with at least one virtual world image at block 406 includes receiving at least one indication of at least one region associated with at least one social networking obtained image.

In one embodiment, receiving at least one indication of at least one region associated with at least one horizontal image 408 includes receiving at least one indication of at least one region associated with at least one ground-level view image. In another embodiment, receiving at least one indication of at least one region associated with at least one horizontal image 408 includes receiving at least one indication of at least one region associated with at least one travel path view, such as an area in front of a traveling vehicle or a person. In a further embodiment, receiving at least one indication of at least one region associated with at least one horizontal image 408 includes receiving at least one indication of at least one region associated with at least one rotating horizontal view. In one embodiment, receiving at least one indication of at least one region associated with at least one horizontal image 408 includes receiving at least one indication of at least one region associated with at least one upward view, such as a space, weather, and/or constellation view.

In one embodiment, receiving at least one indication of at least one drawn region associated with at least one image at block 410 includes receiving at least one indication of at least one free-form drawn region associated with at least one image. In another embodiment, receiving at least one indication of at least one drawn region associated with at least one image at block 410 includes receiving at least one indication of at least one snap and/or tap and drag assisted drawn region associated with at least one image. In a further embodiment, receiving at least one indication of at least one drawn region associated with at least one image at block 410 includes receiving at least one indication of at least one KML polygon based region associated with at least one image.

In one embodiment, receiving at least one indication of at least one marker-defined region associated with at least one image at block 412 includes receiving at least one indication of at least one property boundary defined region associated with at least one image. In another embodiment, receiving at least one indication of at least one marker-defined region associated with at least one image at block 412 includes receiving at least one indication of at least one country and/or state boundary defined region associated with at least one image. In a further embodiment, receiving at least one indication of at least one marker-defined region associated with at least one image at block 412 includes receiving at least one indication of at least one travel path and/or roadway defined region associated with at least one image. In another embodiment, receiving at least one indication of at least one marker-defined region associated with at least one image at block 412 includes receiving at least one indication of at least one zoning and/or districting defined region associated with at least one image.

In one embodiment, receiving at least one indication of at least one coordinate-defined region associated with at least one image at block 414 includes receiving at least one indication of at least one latitude and/or longitude defined region associated with at least one image. In another embodiment, receiving at least one indication of at least one coordinate-defined region associated with at least one image at block 414 includes receiving at least one indication of at least one X/Y axis defined region associated with at least one image. In a further embodiment, receiving at least one indication of at least one coordinate-defined region associated with at least one image at block 414 includes receiving at least one indication of at least one regularly and/or irregularly shaped region associated with at least one image. In yet another embodiment, receiving at least one indication of at least one coordinate-defined region associated with at least one image at block 414 includes receiving at least one indication of at least one region created and/or shared by one or more other individuals associated with at least one image. In one embodiment, receiving at least one indication of at least one coordinate-defined region associated with at least one image at block 414 includes receiving at least one indication of at least one computer-suggested region associated with at least one image.

In one embodiment, receiving at least one indication of at least one placemark-defined region associated with at least one image at block 416 includes receiving at least one indication of at least one landmark defined region associated with at least one image. In one embodiment, receiving at least one indication of at least one placemark-defined region associated with at least one image at block 416 includes receiving at least one indication of at least one marker plus specified radius defined region associated with at least one image. In one embodiment, receiving at least one indication of at least one placemark-defined region associated with at least one image at block 416 includes receiving at least one indication of at least one laser, mouse, and/or pointer type defined region associated with at least one image. In one embodiment, receiving at least one indication of at least one placemark-defined region associated with at least one image at block 416 includes receiving at least one indication of at least one category defined region associated with at least one image.

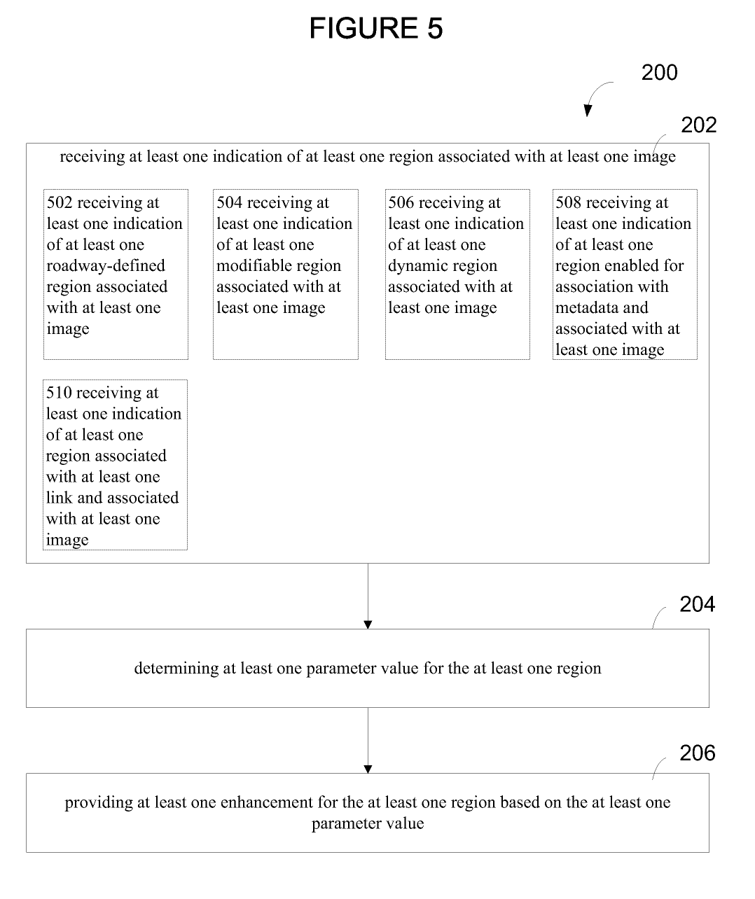

FIG. 5 is a block diagram of method operations for thematic map creation, in accordance with various embodiments of the invention. In one embodiment, method 200 includes receiving at least one indication of at least one roadway-defined region associated with at least one image at block 502, receiving at least one indication of at least one modifiable region associated with at least one image at block 504, receiving at least one indication of at least one dynamic region associated with at least one image at block 506, receiving at least one indication of at least one region enabled for association with metadata and associated with at least one image at block 508, and/or receiving at least one indication of at least one region associated with at least one link and associated with at least one image at block 510.

In one embodiment, receiving at least one indication of at least one roadway-defined region associated with at least one image at block 502 includes receiving at least one indication of at least one freeway, highway, interstate, street, and/or private road defined region associated with at least one image. In another embodiment, receiving at least one indication of at least one roadway-defined region associated with at least one image at block 502 includes receiving at least one indication of at least one walking path and/or sidewalk defined region associated with at least one image. In a further embodiment, receiving at least one indication of at least one roadway-defined region associated with at least one image at block 502 includes receiving at least one indication of at least one air and or flight path defined region associated with at least one image.

In one embodiment, receiving at least one indication of at least one modifiable region associated with at least one image at block 504 includes receiving at least one indication of at least one boundary adjustable region associated with at least one image. In yet another embodiment, receiving at least one indication of at least one modifiable region associated with at least one image at block 504 includes receiving at least one indication of at least one polygon and/or grid snap-to-type adjustable region associated with at least one image. In another embodiment, receiving at least one indication of at least one modifiable region associated with at least one image at block 504 includes receiving at least one indication of at least one variously definable region (e.g. rotate through road, zone, block, district, and/or government boundary defined region) associated with at least one image. In another embodiment, receiving at least one indication of at least one modifiable region associated with at least one image at block 504 includes receiving at least one indication of at least one deletable, hidable, removable, and/or addable region associated with at least one image.

In one embodiment, receiving at least one indication of at least one dynamic region associated with at least one image at block 506 includes receiving at least one indication of at least one region that automatically updates based on changes to the boundaries defining the region, such as road, zoning, districting, and/or city limit type changes. In another embodiment, receiving at least one indication of at least one dynamic region associated with at least one image at block 506 includes receiving at least one indication of at least one dynamic region that combines with adjacent regions when appropriate, such as when adjacent regions having the same or similar parameter values. In a further embodiment, receiving at least one indication of at least one dynamic region associated with at least one image at block 506 includes receiving at least one indication of at least one dynamic region that separates when appropriate, such as when the region has different parameter values or when a threshold is reached (e.g. income gap being greater than $100k).

In one embodiment, receiving at least one indication of at least one region enabled for association with metadata and associated with at least one image at block 508 includes receiving at least one indication of at least one region enabled for association with title and/or note information. In another embodiment, receiving at least one indication of at least one region enabled for association with metadata and associated with at least one image at block 508 includes receiving at least one indication of at least one region enabled for association with information based on the underlying image, such as the State of Washington being identified when a region is defined by the State of Washington. In one embodiment, receiving at least one indication of at least one region enabled for association with metadata and associated with at least one image at block 508 includes receiving at least one indication of at least one region enabled for association with user-specified metadata. In one embodiment, receiving at least one indication of at least one region enabled for association with metadata and associated with at least one image at block 508 includes receiving at least one indication of at least one region enabled for association with searchable metadata.

In one embodiment, receiving at least one indication of at least one region associated with at least one link and associated with at least one image at block 510 includes receiving at least one indication of at least one region associated with at least one link to at least one other region and/or image. In another embodiment, receiving at least one indication of at least one region associated with at least one link and associated with at least one image at block 510 includes receiving at least one indication of at least one region associated with at least one hyperlink. In a further embodiment, receiving at least one indication of at least one region associated with at least one link and associated with at least one image at block 510 includes receiving at least one indication of at least one region associated with at least one social networking, contact, and/or communication link. In another embodiment, receiving at least one indication of at least one region associated with at least one link and associated with at least one image at block 510 includes receiving at least one indication of at least one region associated with at least one camera, and/or video link. In another embodiment, receiving at least one indication of at least one region associated with at least one link and associated with at least one image at block 510 includes receiving at least one indication of at least one region associated with at least one user-specified link. In another embodiment, receiving at least one indication of at least one region associated with at least one link and associated with at least one image at block 510 includes receiving at least one indication of at least one region associated with at least one document, file, contact, and/or social media network type link.

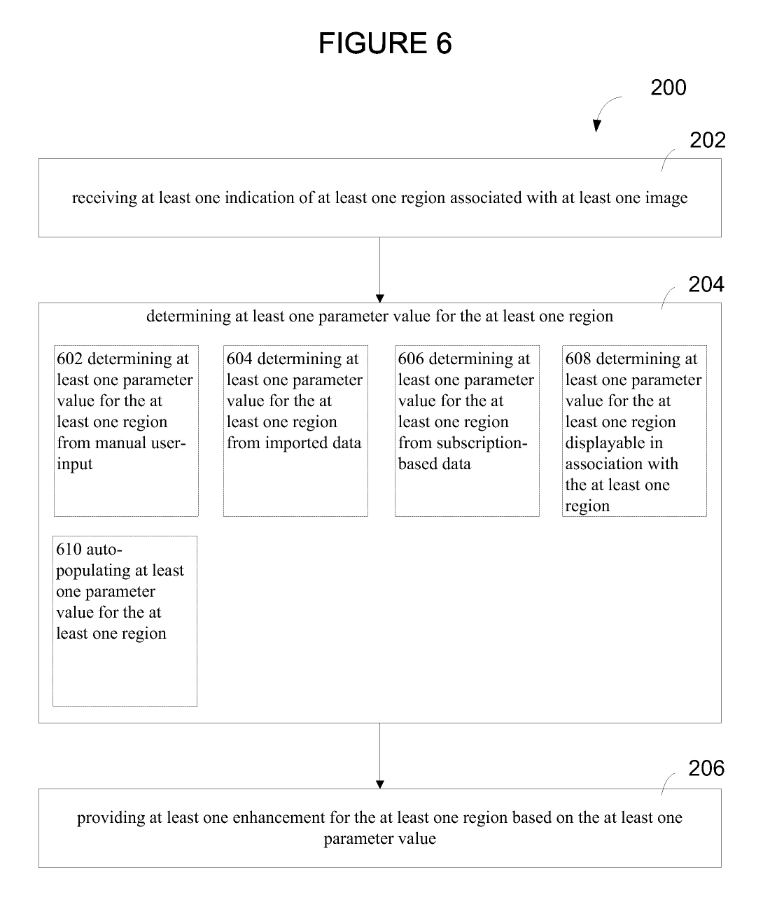

FIG. 6 is a block diagram of method operations for thematic map creation, in accordance with various embodiments of the invention. In one embodiment, method 200 includes determining at least one parameter value for the at least one region from manual user-input at block 602, determining at least one parameter value for the at least one region from imported data at block 604, determining at least one parameter value for the at least one region from subscription-based data at block 606, determining at least one parameter value for the at least one region displayable in association with the at least one region at block 608, and/or auto-populating at least one parameter value for the at least one region at block 610.

In one embodiment, determining at least one parameter value for the at least one region from manual user-input at block 602 includes determining at least one parameter value for the at least one region from at least one selection of one or more options, such as political party, education level, age, health, income, profession, and/or density options or the like. In another embodiment, determining at least one parameter value for the at least one region from manual user-input at block 602 includes determining at least one parameter value for the at least one region from one or more percentage inputs, such as discrete value, range, and/or approximation input or the like. In a further embodiment, determining at least one parameter value for the at least one region from manual user-input at block 602 includes determining at least one parameter value for the at least one region from one or more ratio inputs, such as numerator/denominator and/or decimal input or the like. In yet another embodiment, determining at least one parameter value for the at least one region from manual user-input at block 602 includes determining at least one parameter value for the at least one region from one or more specified values, such as numerical, non-numerical, special character, and/or alphanumeric values or the like.

In one embodiment, determining at least one parameter value for the at least one region from imported data at block 604 includes determining at least one parameter value for the at least one region from one or more MICROSOFT OFFICE data sources, such as EXCEL, WORD, ACCESS, and/or SQL data sources or the like. In another embodiment, determining at least one parameter value for the at least one region from imported data at block 604 includes determining at least one parameter value for the at least one region from imported data that specifies at least the at least one region and the at least one parameter value associated with the at least one region. In one embodiment, determining at least one parameter value for the at least one region from imported data at block 604 includes determining at least one parameter value for the at least one region from imported data that is user-assignable to the at least one region.

In one embodiment, determining at least one parameter value for the at least one region from subscription-based data at block 606 includes determining at least one parameter value for the at least one region from subscription-based data automatically identified based on the at least one region and/or the at least one image, such as San Francisco-related data identified based on an image of San Francisco. In one embodiment, determining at least one parameter value for the at least one region from subscription-based data at block 606 includes determining at least one parameter value for the at least one region from automatically updating subscription-based data, such as crime incidence data associated with a particular region of a city map image updating based on occurrence and/or reporting of crime in that particular region. In one embodiment, determining at least one parameter value for the at least one region from subscription-based data at block 606 includes determining at least one parameter value for the at least one region from multiple sources of information, such as from a plurality of mobile phones reporting traffic, weather, and/or purchase information.

In one embodiment, determining at least one parameter value for the at least one region displayable in association with the at least one region at block 608 includes determining at least one parameter value for the at least one region displayable in one or more pop-up windows upon selection of the at least one region. In another embodiment, determining at least one parameter value for the at least one region displayable in association with the at least one region at block 608 includes determining at least one parameter value for the at least one region displayable within, over, and/or across the at least one region. In a further embodiment, determining at least one parameter value for the at least one region displayable in association with the at least one region at block 608 includes determining at least one parameter value for the at least one region audibly outputable upon selection of the at least one region. In an additional embodiment, determining at least one parameter value for the at least one region displayable in association with the at least one region at block 608 includes determining at least one parameter value for the at least one region displayable with one layer of two or more layers associated with the at least one region (e.g., a map image can have different layers for parameter values of elected representative party, population density, income distribution, and/or school districting or the like).

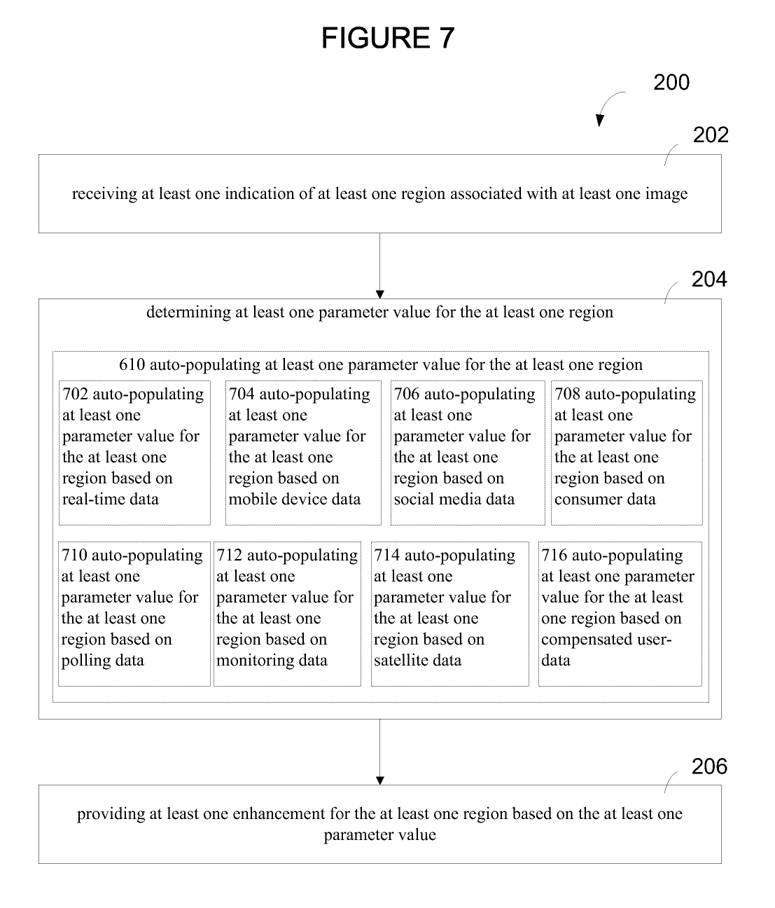

FIG. 7 is a block diagram of method operations for thematic map creation, in accordance with various embodiments of the invention. In one embodiment, method 200 includes auto-populating at least one parameter value for the at least one region at block 610. In one embodiment, auto-populating at least one parameter value for the at least one region at block 610 includes auto-populating at least one parameter value for the at least one region based on real-time data at block 702, auto-populating at least one parameter value for the at least one region based on mobile device data at block 704, auto-populating at least one parameter value for the at least one region based on social media data at block 706, auto-populating at least one parameter value for the at least one region based on consumer data at block 708, auto-populating at least one parameter value for the at least one region based on polling data at block 710, auto-populating at least one parameter value for the at least one region based on monitoring data at block 712, auto-populating at least one parameter value for the at least one region based on satellite data at block 714, and/or auto-populating at least one parameter value for the at least one region based on compensated user-data at block 716.

In one embodiment, auto-populating at least one parameter value for the at least one region based on real-time data at block 702 includes auto-populating at least one parameter value for the at least one region based on mobile phone data, such as one or more mobile phones providing location information indicating presence within the at least one region. In another embodiment, auto-populating at least one parameter value for the at least one region based on real-time data at block 702 includes auto-populating at least one parameter value for the at least one region based on polling data, such as one or more individuals providing answers and/or location information in response to an internet, telephone, television, and/or display screen poll or the like (e.g., sports stadium trivia answers plus seating information). In a further embodiment, auto-populating at least one parameter value for the at least one region based on real-time data at block 702 includes auto-populating at least one parameter value for the at least one region based on at least one information feed, such as consumer purchase data and/or sales tracking/calling data or the like. In yet a further embodiment, auto-populating at least one parameter value for the at least one region based on real-time data at block 702 includes auto-populating at least one parameter value for the at least one region based on sensor, camera, and/or video data or the like (e.g., receiving height, age, sex, and/or weight information or the like associated with street and/or sidewalk passersby).

In one embodiment, auto-populating at least one parameter value for the at least one region based on mobile device data at block 704 includes auto-populating at least one parameter value for the at least one region based on mobile phone data, such as call and/or data traffic information associated with the at least one region. In a further embodiment, auto-populating at least one parameter value for the at least one region based on mobile device data at block 704 includes auto-populating at least one parameter value for the at least one region based on mobile tracking device data, such as health monitoring data for patients or movement information associated with criminals, accused, and/or convicts or the like. In another embodiment, auto-populating at least one parameter value for the at least one region based on mobile device data at block 704 includes auto-populating at least one parameter value for the at least one region based on mobile computer data, such as foot traffic density, automobile traffic flow, and/or weather data or the like.

In one embodiment, auto-populating at least one parameter value for the at least one region based on social media data at block 706 includes auto-populating at least one parameter value for the at least one region based on friend or friend-of-friend locations (e.g. a map showing density within nightclub areas of a city of FACEBOOK and/or GOOGLE friends or the like). In one embodiment, auto-populating at least one parameter value for the at least one region based on social media data at block 706 includes auto-populating at least one parameter value for the at least one region based on club and/or association opinions, such as receiving answers to political questions and/or candidate choice from members of a political organization and/or group or the like. In one embodiment, auto-populating at least one parameter value for the at least one region based on social media data at block 706 includes auto-populating at least one parameter value for the at least one region based on information disclosed on one or more social media sites, such as income, education, and/or profession data plus address information.

In one embodiment, auto-populating at least one parameter value for the at least one region based on consumer data at block 708 includes auto-populating at least one parameter value for the at least one region based on purchase data, such as credit and/or debit card purchase information (e.g., amount, item, and/or location information or the like). In a further embodiment, auto-populating at least one parameter value for the at least one region based on consumer data at block 708 includes auto-populating at least one parameter value for the at least one region based on sensor, video, and/or camera data, such as density of consumers within areas of a store or path usage information associated with a shopping area.

In one embodiment, auto-populating at least one parameter value for the at least one region based on polling data at block 710 includes auto-populating at least one parameter value for the at least one region based on mobile device polling data, such as a question about views on a presidential candidate's debate performance. In another embodiment, auto-populating at least one parameter value for the at least one region based on polling data at block 710 includes auto-populating at least one parameter value for the at least one region based on commercial polling data, such as questions presented during a commercial to solicit feedback about an advertiser, product, and/or service or the like. In a further embodiment, auto-populating at least one parameter value for the at least one region based on polling data at block 710 includes auto-populating at least one parameter value for the at least one region based on physical polling data, such as that from one or more one-on-one interactions between a poller and a pollee.

In one embodiment, auto-populating at least one parameter value for the at least one region based on monitoring data at block 712 includes auto-populating at least one parameter value for the at least one region based on roadway monitoring data, such as traffic flow and/or density sensors or the like. In another embodiment, auto-populating at least one parameter value for the at least one region based on monitoring data at block 712 includes auto-populating at least one parameter value for the at least one region based on motion, presence, and/or movement sensors, such as physical activity information obtained from XBOX or Wii video game console sensors and/or exercise machine sensors. In one embodiment, auto-populating at least one parameter value for the at least one region based on monitoring data at block 712 includes auto-populating at least one parameter value for the at least one region based on monitoring data obtained from one or more set-top boxes, such as television viewing duration and channel information from a satellite and/or cable television console.

In one embodiment, auto-populating at least one parameter value for the at least one region based on satellite data at block 714 includes auto-populating at least one parameter value of building and/or human density information or the like from satellite information. In another embodiment, auto-populating at least one parameter value for the at least one region based on satellite data at block 714 includes auto-populating at least one parameter value of traffic flow, backup, and/or density information or the like from satellite information. In a further embodiment, auto-populating at least one parameter value for the at least one region based on satellite data at block 714 includes auto-populating at least one parameter value with geographic comparison information obtained from one or more satellites, such as comparing images over time to determine degree of wreckage resulting from a natural disaster such as a tsunami, earthquake, fire, volcano eruption, and/or flood or the like (e.g., region 1 is 50% destroyed and region 2 is 99% destroyed).

In one embodiment, auto-populating at least one parameter value for the at least one region based on compensated user-data at block 716 includes auto-populating at least one parameter value for the at least one region based on monetary, coupon, discount, reward, and/or point compensated data or the like. In another embodiment, auto-populating at least one parameter value for the at least one region based on compensated user-data at block 716 includes auto-populating at least one parameter value for the at least one region based on compensated user-data and facilitating compensation, such as by transferring funds to a data source or payment distributor. In a further embodiment, auto-populating at least one parameter value for the at least one region based on compensated user-data at block 716 includes auto-populating at least one 620 parameter value for the at least one region based on compensated user-data that varies in accuracy and/or sample size based on compensation, such as income within a margin of error of 0.05% as opposed to 0.25% for an additional fee or political views of 100k individuals as opposed to 25k for an additional fee or the like.

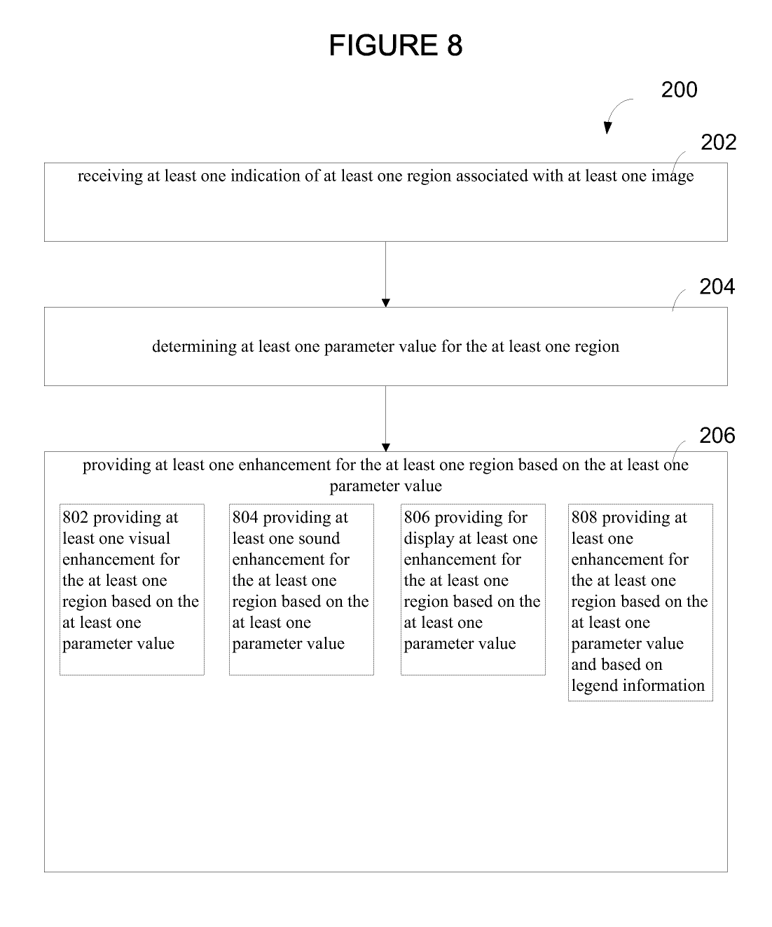

FIG. 8 is a block diagram of method operations for thematic map creation, in accordance with various embodiments of the invention. In one embodiment, method 200 includes providing at least one visual enhancement for the at least one region based on the at least one parameter value at block 802, providing at least one sound enhancement for the at least one region based on the at least one parameter value at block 804, providing for display at least one enhancement for the at least one region based on the at least one parameter value at block 806, and/or providing at least one enhancement for the at least one region based on the at least one parameter value and based on legend information at block 808.

In one embodiment, providing at least one visual enhancement for the at least one region based on the at least one parameter value at block 802 includes providing at least one visual border and/or fill enhancement for the at least one region based on the at least one parameter value at block. In another embodiment, providing at least one visual enhancement for the at least one region based on the at least one parameter value at block 802 includes providing at least one visual color, shading, and/or hatching enhancement for the at least one region based on the at least one parameter value at block. In a further embodiment, providing at least one visual enhancement for the at least one region based on the at least one parameter value at block 802 includes providing at least one visual enhancement for the at least one region that varies automatically based on the at least one parameter value at block (e.g. providing a lighter color for regions with the smallest average education level, a darker color for regions with the highest average education level, and gradations therebetween without requiring user selection).

In one embodiment, providing at least one sound enhancement for the at least one region based on the at least one parameter value at block 804 includes providing at least one rollover-type sound enhancement for the at least one region based on the at least one parameter value, such as a chime or melody that occurs on a mouse over and/or mouse click event with respect to a region. In another embodiment, providing at least one sound enhancement for the at least one region based on the at least one parameter value at block 804 includes providing at least one narrative enhancement for the at least one region based on the at least one parameter value, such as a verbal explanation of data associated with the region (e.g., a user may record the narrative with his/her own voice). In a further embodiment, providing at least one sound enhancement for the at least one region based on the at least one parameter value at block 804 includes providing at least one benchmark triggered sound enhancement for the at least one region based on the at least one parameter value, such as an alert sound that indicates data associated with a region has exceeded a specified threshold.

In one embodiment, providing for display at least one enhancement for the at least one region based on the at least one parameter value at block 806 includes providing for local computer display at least one enhancement for the at least one region based on the at least one parameter value. In another embodiment, providing for display at least one enhancement for the at least one region based on the at least one parameter value at block 806 includes distributing for display at least one enhancement for the at least one region based on the at least one parameter value (e.g., a team of individuals may each be working on a common map and changes made by one of the individuals can be distributed for review by each of the other individuals. In a further embodiment, providing for display at least one enhancement for the at least one region based on the at least one parameter value at block 806 includes providing for printing, saving, exporting, and/or sharing at least one enhancement for the at least one region based on the at least one parameter value.

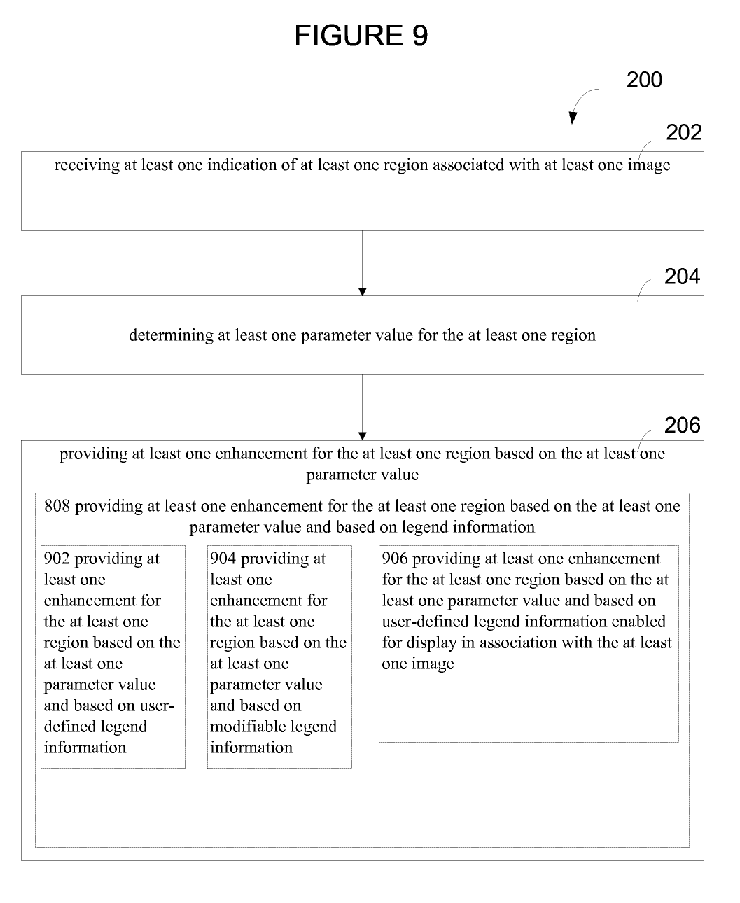

FIG. 9 is a block diagram of method operations for thematic map creation, in accordance with various embodiments of the invention. In one embodiment, providing at least one enhancement for the at least one region based on the at least one parameter value and based on legend information at block 808 includes providing at least one enhancement for the at least one region based on the at least one parameter value and based on user-defined legend information at block 902, providing at least one enhancement for the at least one region based on the at least one parameter value and based on modifiable legend information at block 904, and/or providing at least one enhancement for the at least one region based on the at least one parameter value and based on user-defined legend information enabled for display in association with the at least one image at block 906.

In one embodiment, providing at least one enhancement for the at least one region based on the at least one parameter value and based on user-defined legend information at block 902 includes providing at least one enhancement for the at least one region based on the at least one parameter value and based on user-defined legend color shading information (e.g., a user can specify different shades of colors for different parameter values, which are then associated with the region based on the parameter value of the region). In another embodiment, providing at least one enhancement for the at least one region based on the at least one parameter value and based on user-defined legend information at block 902 includes providing at least one enhancement for the at least one region based on the at least one parameter value and based on assisted user-defined legend information (e.g., colors or shading can be suggested to the user based on the range of parameter values to facilitate a professional appearing map).

In one embodiment, providing at least one enhancement for the at least one region based on the at least one parameter value and based on modifiable legend information at block 904 includes providing at least one enhancement for the at least one region based on the at least one parameter value and based on editable legend information. In one embodiment, providing at least one enhancement for the at least one region based on the at least one parameter value and based on modifiable legend information at block 904 includes providing at least one enhancement for the at least one region based on the at least one parameter value and based on movable, hidable, and/or minimizable legend information.

In one embodiment, providing at least one enhancement for the at least one region based on the at least one parameter value and based on user-defined legend information enabled for display in association with the at least one image at block 906 includes providing at least one enhancement for the at least one region based on the at least one parameter value and based on user-defined legend information enabled for moving display (e.g., the legend can follow cursor movement to allow quick reference of the legend information). In another embodiment, providing at least one enhancement for the at least one region based on the at least one parameter value and based on user-defined legend information enabled for display in association with the at least one image at block 906 includes providing at least one enhancement for the at least one region based on the at least one parameter value and based on user-defined legend information enabled for highlightable display (e.g., on moving over a region shaded blue, the associated parameter value of Republican in the legend is highlighted). In one embodiment, providing at least one enhancement for the at least one region based on the at least one parameter value and based on user-defined legend information enabled for display in association with the at least one image at block 906 includes providing at least one enhancement for the at least one region based on the at least one parameter value and based on user-defined multi-level legend information enabled for display in association with the at least one image (e.g., a legend can have two or more levels for different parameters such as political party, income distribution, age, literacy, crime, homelessness and selection of a particular level can display the parameter values for that level and enhance the map regions based on the parameter values and assigned enhancements).

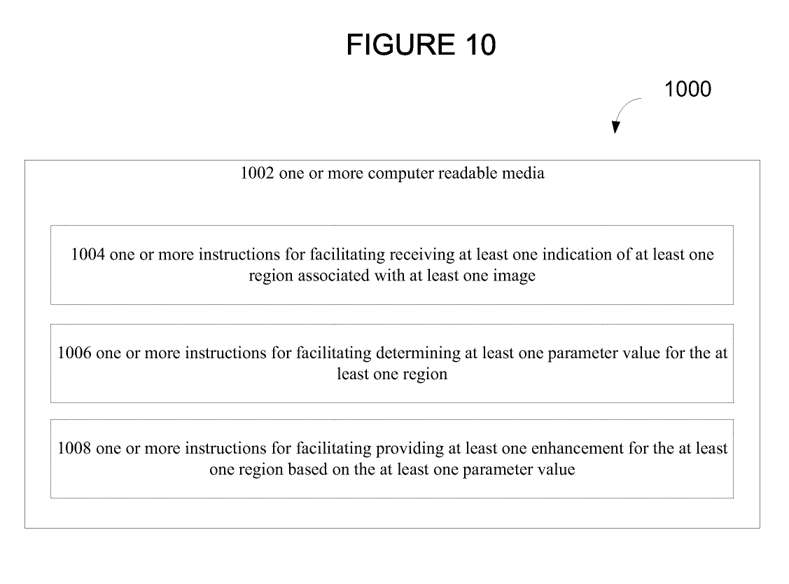

FIG. 10 is a diagram of computer readable media bearing one or more instructions for thematic map creation. In one embodiment, media 1000 includes one or more instructions for receiving at least one indication of at least one region associated with at least one image, one or more instructions for determining at least one parameter value for the at least one region, and one or more instructions for providing at least one enhancement for the at least one region based on the at least one parameter value. Media 1000 can further include one or more instructions for performing any operation or collection of operations disclosed herein. Media 1000 can include a recordable type medium such as a floppy disk, a hard disk drive, a Compact Disc (CD), a Digital Video Disk (DVD), a digital tape, a computer memory, etc.; and/or a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

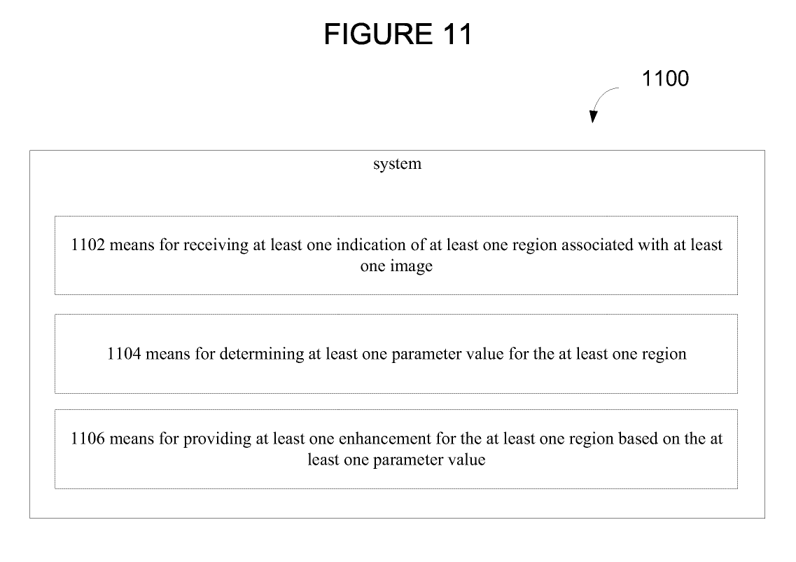

FIG. 11 is a diagram of a system for thematic map creation. In one embodiment, system 1100 includes means for receiving at least one indication of at least one region associated with at least one image at block 1102; means for determining at least one parameter value for the at least one region at block 1104; and means for providing at least one enhancement for the at least one region based on the at least one parameter value at block 1106. System 1100 can further include means for performing any operation or collection of operations disclosed herein. System 1100 may include Application Specific Integrated Circuits (ASICs), Field Programmable Gate Arrays (FPGAs), and/or digital signal processors (DSPs) or the like.

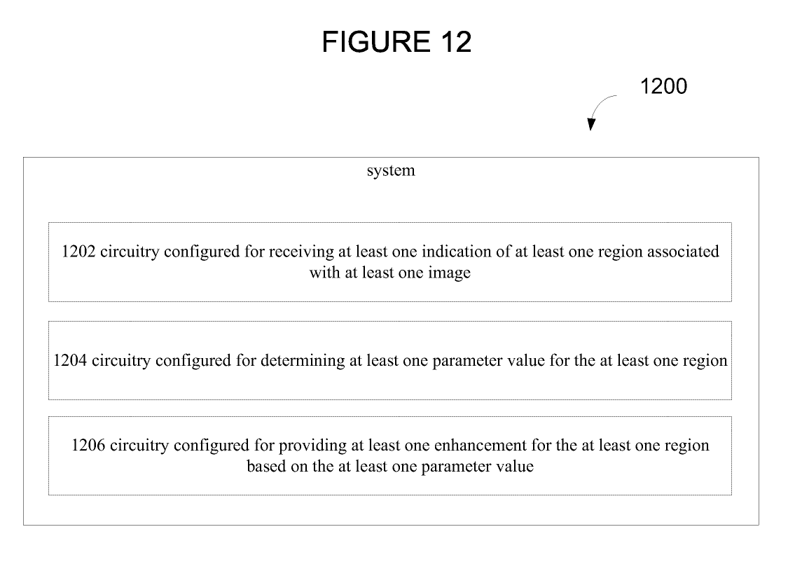

FIG. 12 is a diagram of a system for thematic map creation in one embodiment, system 1200 includes circuitry configured for receiving at least one indication of at least one region associated with at least one image at block 1202, circuitry configured for determining at least one parameter value for the at least one region at block 1204, and circuitry configured for providing at least one enhancement for the at least one region based on the at least one parameter value at block 1206. System 1200 can further include circuitry for performing any operation or collection of operations disclosed herein. System 1200 may include Application Specific Integrated Circuits (ASICs), Field Programmable Gate Arrays (FPGAs), and/or digital signal processors (DSPs) or the like.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A system comprising:
circuitry configured for receiving at least one indication of at least one region associated with at least one image;
circuitry configured for determining at least one parameter value for the at least one region; and
circuitry configured for providing at least one enhancement for the at least one region based on the at least one parameter value.

2. The system of claim 1, wherein the circuitry configured for receiving at least one indication of at least one region associated with at least one image comprises:
circuitry configured for receiving at least one indication of at least one region associated with at least one geographic map image.

3. (canceled)

4. (canceled)

5. (canceled)

6. The system of claim 1, wherein the circuitry configured for receiving at least one indication of at least one region associated with at least one image comprises:
circuitry configured for receiving at least one indication of at least one region associated with at least one dynamic image.

7. The system of claim 1, wherein the circuitry configured for receiving at least one indication of at least one region associated with at least one image comprises:
circuitry configured for receiving at least one indication of at least one region associated with at least one imported image.

8. The system of claim 1, wherein the circuitry configured for receiving at least one indication of at least one region associated with at least one image comprises:
circuitry configured for receiving at least one indication of at least one region associated with at least one user-created image.

9. The system of claim 1, wherein the circuitry configured for receiving at least one indication of at least one region associated with at least one image comprises:
circuitry configured for receiving at least one indication of at least one region associated with at least one image selected at least partly based on at least one current location determination.

10. (canceled)

11. (canceled)

12. (canceled)

13. (canceled)

14. The system of claim 1, wherein the circuitry configured for receiving at least one indication of at least one region associated with at least one image comprises:
circuitry configured for receiving at least one indication of at least one drawn region associated with at least one image.

15. The system of claim 1, wherein the circuitry configured for receiving at least one indication of at least one region associated with at least one image comprises:
circuitry configured for receiving at least one indication of at least one marker-defined region associated with at least one image.

16. (canceled)

17. (canceled)

18. The system of claim 1, wherein the circuitry configured for receiving at least one indication of at least one region associated with at least one image comprises:
circuitry configured for receiving at least one indication of at least one roadway-defined region associated with at least one image.

19. The system of claim 1, wherein the circuitry configured for receiving at least one indication of at least one region associated with at least one image comprises:
circuitry configured for receiving at least one indication of at least one modifiable region associated with at least one image.

20. The system of claim 1, wherein the circuitry configured for receiving at least one indication of at least one region associated with at least one image comprises:
circuitry configured for receiving at least one indication of at least one dynamic region associated with at least one image.

21. (canceled)

22. (canceled)

23. The system of claim 1, wherein the circuitry configured for determining at least one parameter value for the at least one region comprises:
circuitry configured for determining at least one parameter value for the at least one region from manual user-input.

24. (canceled)

25. (canceled)

26. (canceled)

27. The system of claim 1, wherein the circuitry configured for determining at least one parameter value for the at least one region comprises:
circuitry configured for auto-populating at least one parameter value for the at least one region.

28. The system of claim 27, wherein the circuitry configured for auto-populating at least one parameter value for the at least one region comprises:
circuitry configured for auto-populating at least one parameter value for the at least one region based on real-time data.

29. The system of claim 27, wherein the circuitry configured for auto-populating at least one parameter value for the at least one region comprises:
circuitry configured for auto-populating at least one parameter value for the at least one region based on mobile device data.

30. The system of claim 27, wherein the circuitry configured for auto-populating at least one parameter value for the at least one region comprises:
circuitry configured for auto-populating at least one parameter value for the at least one region based on social media data.

31. The system of claim 27, wherein the circuitry configured for auto-populating at least one parameter value for the at least one region comprises:
circuitry configured for auto-populating at least one parameter value for the at least one region based on consumer data.

32. The system of claim 27, wherein the circuitry configured for auto-populating at least one parameter value for the at least one region comprises:
circuitry configured for auto-populating at least one parameter value for the at least one region based on polling data.

33. (canceled)

34. (canceled)

35. (canceled)

36. (canceled)

37. (canceled)

38. (canceled)

39. The system of claim 1, wherein the circuitry configured for providing at least one enhancement for the at least one region based on the at least one parameter value comprises:
circuitry configured for providing at least one enhancement for the at least one region based on the at least one parameter value and based on legend information.

40. The system of claim 39, wherein the circuitry configured for providing at least one enhancement for the at least one region based on the at least one parameter value and based on legend information comprises:
circuitry configured for providing at least one enhancement for the at least one region based on the at least one parameter value and based on user-defined legend information.

41. (canceled)

42. (canceled)

43. (canceled)

44. (canceled)

45. (canceled)
